(19) United States
(12) Patent Application Publication
(10) Pub. No.: US 2017/0140394 A1
(43) Pub. Date: May 18, 2017

(54) CONSENSUS-BASED REPUTATION TRACKING IN ONLINE MARKETPLACES

(71) Applicant: International Business Machines Corporation, Armonk, NY (US)

(72) Inventors: Feng Cao, Shanghai (CN); Boliang Chen, Shanghai (CN); Andreas Kind, Zurich (CH); Yuan Ni, Shanghai (CN); Fei Su, Shanghai (CN); Wei Zhao, Shanghai (CN)

(21) Appl. No.: 14/945,389

(22) Filed: Nov. 18, 2015

(51) Int. Cl. G06Q 30/02

(52) U.S. Cl. CPC G06Q 30/0201

(57) ABSTRACT

Systems and techniques for blockchain-based reputation tracking in an online marketplace include and/or are configured for: receiving a rate reputation request, the rate reputation request relating to a transaction attempt between at least two entities in the online marketplace; determining a plurality of reputation factors; and determining a reputation adjustment for one or more of the entities participating in the transaction attempt. The reputation adjustment is based at least in part on one or more of the reputation factors, which include: validity of the transaction attempt to which the rate reputation request relates; historical proportion of transactions conducted between the at least two entities participating in the transaction attempt; historical proportion of reputation currency transferred between the entities participating in the transaction attempt; and/or confidence of the validator node with respect to the entities.

### BACKGROUND

The present invention relates to online trading, and more specifically, this invention relates to consensus-based reputation tracking in online transactions.

The online marketplace provides access to a nearly limitless supply and variety of goods and services and allows consumers and suppliers to transact in ways otherwise impossible. In addition, by creating a broad, e.g. worldwide, marketplace, online commerce provides greater opportunity for competition. This increased competition benefits consumers and suppliers according to well-known free-market principles.

However, this increased accessibility and competition of the online marketplace comes at a cost. The absence of any physical or direct interaction between the buyer and seller, or the consumer and the product or service(s) offered creates opportunities for mistake, misunderstanding, and even fraud.

To provide consumer protection, the online community has developed techniques for validating authenticity of transactions, e.g. using digital signatures, and for consumers to share information regarding their experience with a particular entity, product, service, etc., e.g. online review systems and services.

However, the traditional validation techniques and review systems and services generally rely on the use of a trusted entity. For example, a trusted third party validation service such as PAYPAL® may be employed to manage validation data and functions within online transactions. Similarly, a trusted third party review service such as YELP® may be employed to receive, manage and publish consumer reviews regarding products, services, and/or entities in the online marketplace, building an “online reputation” for each marketplace participant.

These third party validation and review systems and techniques significantly improve the reliability of online transactions, but are uniquely subject to compromise in the context of online trading, e.g. via breaches of security, improper influence on reviews, etc. For instance, in many situations a trusted entity may be compromised, resulting in disclosure of private information, loss of assets, and other now-familiar and significant problems associated with online security breaches.

Similarly, a trusted third party review service provider may offer single entities the ability to influence the information published by the service provider in exchange for a fee, skewing consumers' ability to freely exchange information and the corresponding reliability of the marketplace. Alternatively, a particularly biased consumer (e.g. a friend or foe of a particular seller) may artificially inflate or deflate another entity's online reputation by submitting fictitious, false, and/or misleading information, compromising the integrity of the review system or service.

Accordingly, it would be of great benefit to provide systems and techniques for online marketplace reputation tracking that are robust to invalid transactions and/or improper influence by single entities.

### SUMMARY

In one embodiment, a computer-implemented method for blockchain-based reputation tracking in an online marketplace includes: receiving, at a validator node of the online marketplace, a rate reputation request, the rate reputation request relating to a transaction attempt between at least two entities in the online marketplace; in response to receiving the rate reputation request, determining by the validator node a plurality of reputation factors; and determining, by the validator node, a reputation adjustment for one or more of the at least two entities participating in the transaction attempt. The reputation adjustment is based at least in part on one or more of the plurality of reputation factors, and the reputation factors include a validity of the transaction attempt to which the rate reputation request relates; a historical proportion of transactions conducted between the at least two entities participating in the transaction attempt; a historical proportion of reputation currency transferred between the at least two entities participating in the transaction attempt; and a confidence of the validator node with respect to the at least two entities.

In another embodiment, a computer program product is for consensus-based reputation tracking in an online marketplace. The computer program product includes a computer readable storage medium having stored thereon: first program instructions executable by a validator node of the online marketplace to cause the validator node to receive a rate reputation request, the rate reputation request relating to a transaction attempt between at least two entities in the online marketplace; second program instructions executable by the validator node of the online marketplace to cause the validator node to determine a plurality of reputation factors; and third program instructions executable by the validator node of the online marketplace to cause the validator node to determine a reputation adjustment for one or more of the at least two entities participating in the transaction attempt. The reputation adjustment is based at least in part on one or more of the plurality of reputation factors. The reputation factors include: a validity of the transaction attempt to which the rate reputation request relates; a historical proportion of transactions conducted between the at least two entities participating in the transaction attempt; a historical proportion of reputation currency transferred between the at least two entities participating in the transaction attempt; and a confidence of the validator node with respect to the at least two entities. The computer readable storage medium is not a transitory signal per se.

In yet another embodiment, a system for consensus-based reputation tracking in an online marketplace includes a processor and logic integrated with and/or executable by the processor. The logic is configured to cause the system to perform a method. The method involves: receiving, at a validator node of the online marketplace, a rate reputation request, the rate reputation request relating to a transaction attempt between at least two entities in the online marketplace; in response to receiving the rate reputation request, determining by the validator node a plurality of reputation factors. The factors include: a validity of the transaction attempt to which the rate reputation request relates; a historical proportion of transactions conducted between the at least two entities participating in the transaction attempt; a historical proportion of reputation currency transferred between the at least two entities participating in the transaction attempt; and a confidence of the validator node with respect to the at least two entities. The method also includes determining, by the validator node, a reputation adjustment for one or more of the at least two entities participating in the transaction attempt, the reputation adjustment being based at least in part on one or more of the plurality of reputation factors.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3A illustrates a traditional online trading architecture relying on trusted entity validation.

FIG. 3B illustrates a traditional online trading architecture relying on consensus validation.

FIG. 4 illustrates a flowchart of a method, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for consensus-based reputation tracking in the context of online transactions.

In one general embodiment, a computer-implemented method for blockchain-based reputation tracking in an online marketplace includes: receiving, at a validator node of the online marketplace, a rate reputation request, the rate reputation request relating to a transaction attempt between at least two entities in the online marketplace; in response to receiving the rate reputation request, determining by the validator node a plurality of reputation factors; and determining, by the validator node, a reputation adjustment for one or more of the at least two entities participating in the transaction attempt. The reputation adjustment is based at least in part on one or more of the plurality of reputation factors, and the reputation factors include a validity of the transaction attempt to which the rate reputation request relates; a historical proportion of transactions conducted between the at least two entities participating in the transaction attempt; a historical proportion of reputation currency transferred between the at least two entities participating in the transaction attempt; and a confidence of the validator node with respect to the at least two entities.

In another general embodiment, a computer program product is for consensus-based reputation tracking in an online marketplace. The computer program product includes a computer readable storage medium having stored thereon: first program instructions executable by a validator node of the online marketplace to cause the validator node to receive a rate reputation request, the rate reputation request relating to a transaction attempt between at least two entities in the online marketplace; second program instructions executable by the validator node of the online marketplace to cause the validator node to determine a plurality of reputation factors; and third program instructions executable by the validator node of the online marketplace to cause the validator node to determine a reputation adjustment for one or more of the at least two entities participating in the transaction attempt. The reputation adjustment is based at least in part on one or more of the plurality of reputation factors. The reputation factors include: a validity of the transaction attempt to which the rate reputation request relates; a historical proportion of transactions conducted between the at least two entities participating in the transaction attempt; a historical proportion of reputation currency transferred between the at least two entities participating in the transaction attempt; and a confidence of the validator node with respect to the at least two entities. The computer readable storage medium is not a transitory signal per se.

In yet another general embodiment, a system for consensus-based reputation tracking in an online marketplace includes a processor and logic integrated with and/or executable by the processor. The logic is configured to cause the system to perform a method. The method involves: receiving, at a validator node of the online marketplace, a rate reputation request, the rate reputation request relating to a transaction attempt between at least two entities in the online marketplace; in response to receiving the rate reputation request, determining by the validator node a plurality of reputation factors. The factors include: a validity of the transaction attempt to which the rate reputation request relates; a historical proportion of transactions conducted between the at least two entities participating in the transaction attempt; a historical proportion of reputation currency transferred between the at least two entities participating in the transaction attempt; and a confidence of the validator node with respect to the at least two entities. The method also includes determining, by the validator node, a reputation adjustment for one or more of the at least two entities participating in the transaction attempt, the reputation adjustment being based at least in part on one or more of the plurality of reputation factors.

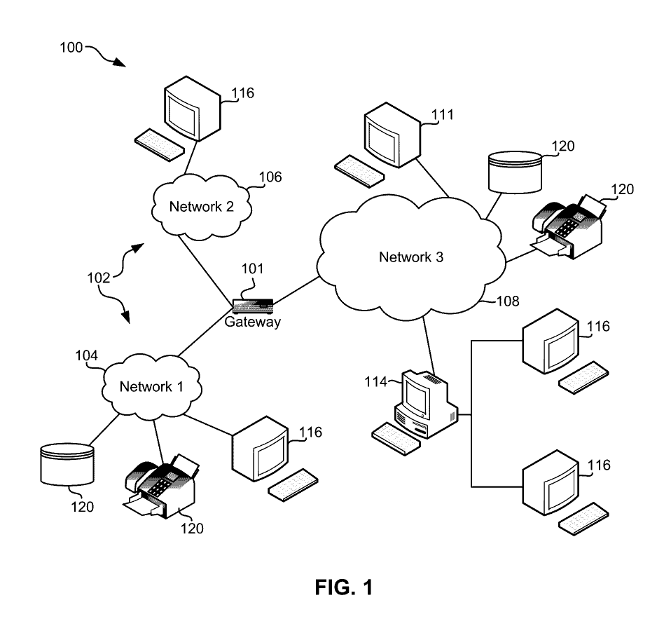

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

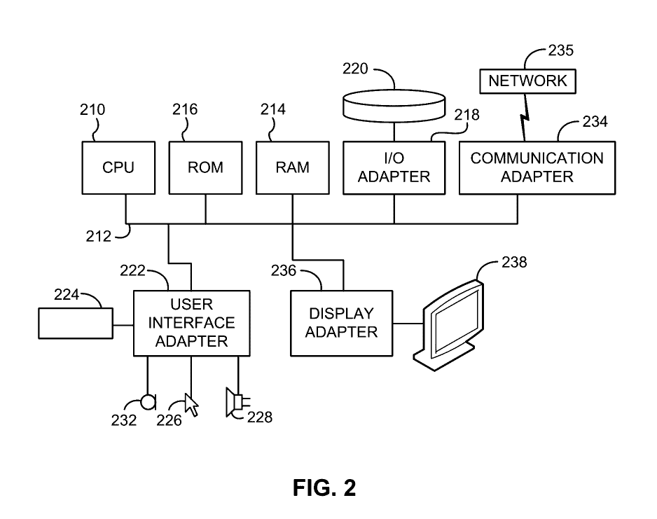

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using XML, C, and/or C++ language, or other programming languages, along with an object oriented programming methodology. Object oriented programming (OOP), which has become increasingly used to develop complex applications, may be used.

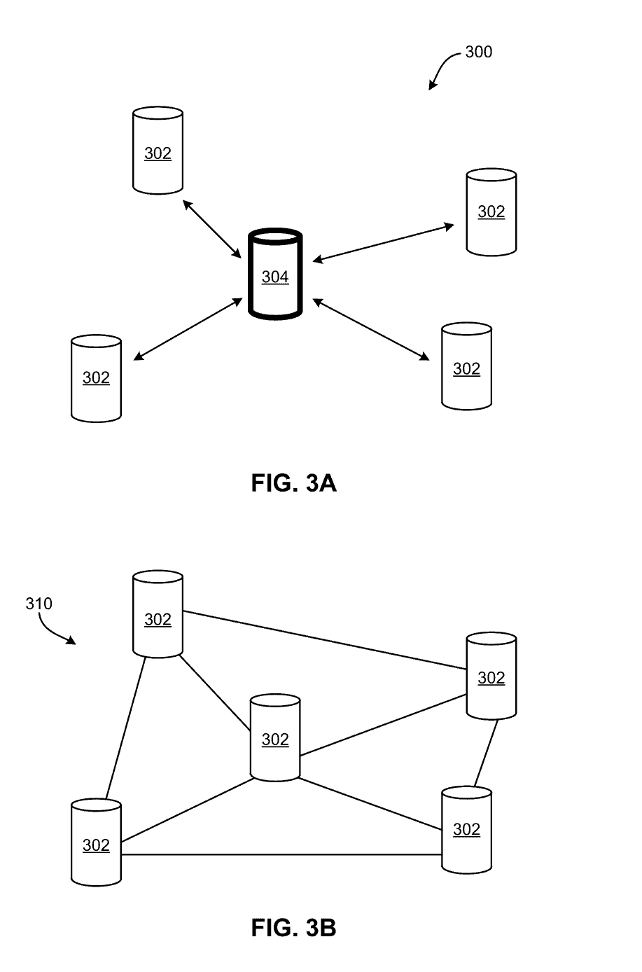

Now referring to FIG. 3A, a conventional online trading architecture 300 relying on trusted-party validation is shown. According to the conventional architecture 300, an online marketplace includes a plurality of entities, such as sellers and buyers 302, and trusted entities 304. In the process of conducting a transaction between any two or more entities 302 of the marketplace, each entity 302 participating in the transaction submits validation data to a trusted entity 304 for validation.

Upon determining each side of the transaction is valid with respect to the entities 302 (e.g. each entity's identity is as represented in the transaction, the seller possesses the product or service requested, and/or the buyer possesses sufficient funds to purchase the goods or services), the trusted entity 304 may complete the transaction.

Upon determining one or both sides of the transaction are invalid with respect to one or more of the entities 302 participating in the transaction (e.g. at least one entity's identity is not as represented in the transaction, and/or is incapable of providing the requested goods, services, or payment) the trusted entity 304 may prevent the transaction.

However, as noted above such conventional systems are subject to breach, and/or improper influence on the validation process by a single entity. Accordingly, one conventional approach to providing improved security and robustness with respect to transaction validation is to employ consensus-based validation such as according to traditional online trading architecture 310 shown in FIG. 3B. In essence, the consensus-based validation approach removes the trusted entity 304 from the architecture 300 shown in FIG. 3A in favor of validating a particular transaction based on consensus approval of one or more, preferably all entities 302 in the architecture 310.

One well-known implementation of such a consensus-based validation is a distributed database, in which a public ledger of transactions is maintained by a plurality of entities 302 in the architecture 310. Upon completing an approved transaction, e.g. between two entities in the architecture 310, a corresponding transaction entry in the public ledger is updated, and the update is distributed across the architecture 310 to the various entities 302 participating in the consensus in the form of a transaction “block” in the public ledger.

Accordingly, in preferred embodiments the presently disclosed inventive concepts are implemented via a consensus-based technique configured to initialize one or more transactions in a “batch” or “block,” process the initialized transactions together (e.g. contemporaneously, as a set, in parallel, etc.), and publish the result of the processing to a plurality of entities 302, e.g. validation nodes, of the architecture 310 prior to initializing a subsequent batch or block of transactions. Via this batch- or block-based processing and subsequent publication of processing results to various entities 302 of an online marketplace, the presently disclosed inventive concepts frustrate or prevent efforts to compromise the integrity of the processed data from improper influence.

In particularly preferred approaches, the presently disclosed inventive concepts are implemented substantially via a modified blockchain framework, in which reputation information are included in the blockchain process according to the techniques and embodiments described herein. The blockchain embodiments particularly help to guarantee that no single party could modify a transaction, ensuring integrity of the underlying reputation rating system. For instance, the blockchain technology includes a distributed, shared ledger and the consensus algorithm. Various applications are proposed by extending the blockchain technology to implement a particular purpose, such as online trading, version control over particular data such as a collaborative document, programming script, shared account, etc. as would be understood by a skilled artisan upon reading the present descriptions.

In order for a subsequent transaction within the architecture 310 to be approved as “valid,” the entities 302 involved in the transaction must have identical information contained in the transaction block created in response to validating the prior transaction and which was distributed across the architecture 310 as discussed above. In other words, for a subsequent transaction to be validated, the transaction information in the prior transaction block of the public ledger stored with each entity 302 involved in the subsequent transaction must match the consensus transaction information stored in the prior transaction blocks of each public ledger of each entity of the architecture 310.

While this conventional implementation of consensus-based validation provides an online marketplace that is robust to fraudulent transactions or attempts perpetrated by a single entity, these systems are not capable of tracking and maintaining reputation information in a manner similarly robust to improper influence by single entities.

Accordingly, the present disclosures relate systems and techniques for consensus-based reputation tracking in an online marketplace. Generally, the presently disclosed inventive concepts implement a distributed database in the form of a public ledger stored and maintained across all data nodes of an online marketplace. Through this public ledger, reputation information is tracked and modified in the form of reputation currency (RC).

In preferred approaches, reputation currency may be expressed in the form of reputation coins, and reputation currency may be tracked, maintained, etc. by defining new data structures and/or new fields within existing data structures implemented by traditional consensus-based validation systems.

For instance, in one approach a block chain data structure typically leveraged for identifying an account for validation purposes may be modified to enable reputation tracking as disclosed herein. The account data structure may include information necessary to conduct transactions in the online marketplace, such as a unique certificate of the account holder (e.g. a digital signature such as an elliptical curve digital signature per the elliptical curve digital signature algorithm (ECDSA) standard). The unique certificate serves to uniquely identify the account holder among other entities, in the same manner as a signature or fingerprint uniquely identifies a particular person.

The account data structure may also include an account header field, which may preferably include a key and a random integer stored in association with one another. More preferably, the key is a public key that uniquely identifies the entity to other entities within the online marketplace, and the public key is associated with a private key that the entity uses to identify itself to the online marketplace. For instance, the public key may be utilized by a buyer to identify a seller with which the buyer wishes to transact, while the seller may then use their private key to validate to the marketplace that the seller wishes to proceed with the transaction proposed by the buyer. Of course, public and private keys may be used on either “side” of the transaction without departing from the scope of the present disclosures.

The exemplary account data structure may also identify assets such as goods and/or services offered by a particular entity, e.g. to facilitate tracking of inventory and processing of transactions with regard to a particular type of asset. For instance, validation may include not only validating the identity of the entities involved in a transaction, but also validating that the entity acting as seller actually possesses the asset(s) in which the buyer is interested.

Similarly, the exemplary account data structure may also identify an amount of currency an entity has available with which to transact. For instance, validation may include not only validating the identity of the entities involved in a transaction, but also validating that the entity acting as buyer actually possesses the requisite funds to complete the transaction.

In this manner, the account data structure facilitates the validation of transactions in online marketplaces. However, neither this nor any other data structure enables consensus-based tracking of reputation information.

Accordingly, the presently disclosed inventive concepts extend to the notion of implementing reputation information in new or existing data structures to facilitate reputation tracking. In a preferred embodiment of this notion, and within the context of block chain distributed databases, an existing account data structure may be modified to include two additional (new) fields: a reputation currency (RC) field, which represents the amount of reputation currency an entity has accumulated; and an account field which identifies the account header in association with the assets of the entity, the amount of currency available to the entity, and the amount of reputation currency the entity has accumulated.

By implementing reputation data in new or existing data structures of online marketplaces, it is possible to provide reputation tracking functionality that is robust to improper influence without introducing significant additional overhead to the online marketplace functionality.

Returning now to the inventive reputation tracking concept, upon validating a transaction attempt, entities participating in the transaction may choose to offer positive or negative feedback, and suggest a modification to their transacting partner's reputation. For instance, the entities might suggest adding or deducting a particular amount of reputation currency to/from their transacting partner's account.

In this manner, the presently disclosed inventive concepts include embodiments where the transacting entity may suggest a sign (i.e. positive or negative) and/or a magnitude (e.g. on a scale from one to five stars) of a reputation adjustment in connection with a particular transaction. Accordingly, the rate reputation request may include an entity-defined sign of the reputation adjustment and an entity-suggested magnitude of the reputation adjustment. Determining the reputation adjustment for entities participating in the transaction attempt may thus include, or even consist entirely of, adjusting the user-suggested magnitude of the reputation adjustment based on: the validity of the transaction attempt to which the rate reputation request relates; the historical proportion of transactions conducted between the at least two entities; the historical proportion of reputation currency transferred between the at least two entities; and/or the confidence of the validator node with respect to the at least two entities. The impact of these various reputation factors will be discussed in further detail below.

Advantageously, the particular manner in which consensus reputation tracking is implemented in embodiments of the presently disclosed inventive concepts provides robustness against improper influence.

For instance, transaction validity may be leveraged as a factor in managing reputation of an entity in an online marketplace. If a particular entity engages in an invalid transaction, for example, it may be appropriate to nullify the impact of the transaction on the entity's reputation. An entity repeatedly attempting to purchase an asset from a nonexistent seller, for example, or a seller with an invalid security certificate

Additionally and/or alternatively, factors such as the number and/or proportion of transactions between particular entities compared to the marketplace as a whole; the total number of transactions for particular entities; the amount and/or proportion of reputation coin transferred between particular entities and/or the marketplace as a whole; the amount and/or proportion of reputation coin transferred to or by particular entities in transactions with particular other entities and/or the marketplace as a whole; etc. as would be understood by a person having ordinary skill in the art upon reading the present descriptions.

The particular manner in which these factors are leveraged to prevent improper influence according to various embodiments will be discussed further below.

As mentioned above, one important aspect of the presently disclosed inventive reputation tracking concepts is robustness to improper influence. Traditionally, improper influence in the context of reputation tracking occurs when a particular entity attempts to artificially influence either its own reputation or the reputation of another entity, e.g. by submitting a large number of positive or negative reviews in order to increase or decrease the reputation of another entity; by submitting misleading reviews or allowing entities to influence their own reputation within the marketplace, etc. as would be understood by a person having ordinary skill in the art upon reading the present descriptions.

As will be further understood by skilled artisans, there are multiple aspects to robustness of a particular reputation tracking system, corresponding to the multiple ways in which the integrity of the reputation tracking system may be compromised. Accordingly, the presently disclosed inventive concepts employ a multifaceted approach to providing tracking system robustness.

For instance, in order to address the problems caused by a particular transaction being fraudulent, it may be useful to exclude invalid transactions from contributing to the reputation tracking functionality. This may be accomplished in some embodiments to setting a reputation adjustment associated with an invalid transaction to a value of zero. In other embodiments, an invalid transaction may be addressed by inverting the sign of a user-defined/suggested reputation adjustment, e.g. converting an invalid attempt at boosting reputation into a resulting reputation detriment.

In order to address scenarios in which a particular entity or set of entities attempt to improperly influence the reputation of another entity, or their own reputation via action of other entities, the presently disclosed reputation tracking techniques take into account the number of transactions conducted between the particular entities involved in the transaction giving rise to the rate reputation request. In particularly preferred approaches, the proportion of these transactions with respect to the total number of transactions between each entity involved in the transaction and other entities not involved in the particular transaction is taken into account.

Thus, with continuing reference to the exemplary scenario involving two entities, in one embodiment reputation tracking involves determining a historical proportion of transactions conducted between the entities participating in the transaction attempt. The historical proportion of transactions conducted between the at least two entities is preferably defined as:

$$\frac{N}{( {N}_{1} + {N}_{2} )}$$

where: N is a historical number of transactions between the at least two entities; N₁ is a number of transactions conducted between a first of the at least two entities and other entities of the online marketplace not participating in the transaction attempt to which the rate reputation request relates; and N₂ is a number of transactions conducted between a second of the at least two entities and other entities of the online marketplace not participating in the transaction attempt to which the rate reputation request relates.

With reference to the exemplary scenario involving more than two entities, in one embodiment reputation tracking involves determining a historical proportion of transactions conducted between the entities participating in the transaction attempt. The historical proportion of transactions conducted between the at least two entities is preferably defined as:

$$\frac{N}{( {N}_{1} + {N}_{2} + … + {N}_{n} )}$$

where: N; N₁ and N₂ are defined as above, and Nₙ is a number of transactions conducted between an optional N^{th} of the at least two entities participating in the transaction attempt and other entities of the online marketplace not participating in the transaction attempt.

In particularly preferred approaches, N is a historical number of transactions between the at least two entities; N₁ is an number of sales completed by the seller entity to other entities of the online marketplace not participating in the transaction attempt to which the present rate reputation request relates; and N₂ is number of purchases completed by a buyer entity from other entities of the online marketplace not participating in the transaction attempt to which the rate reputation request relates. This preferred embodiment facilitates context-aware reputation tracking, in which the historical behavior of the entity is evaluated in the same context as the role that entity is taking in the present transaction (e.g. buyer/seller, etc.).

In order to address the problems caused by a particular entity or set of entities improperly influencing another entity's reputation, e.g. by engaging in multiple transactions accompanied by positive or negative reviews, the above historical transaction information may be utilized to normalize the impact of any particular review as a function of the relative proportion of transactions between the reviewing entity and the reviewed entity compared to transactions between the reviewing entity and other entities and/or the reviewed entity and other entities in the online marketplace. For instance, the historical proportion of transactions may be used as a weight or multiplier to adjust the magnitude of the reputation currency adjustment for a particular transaction. In various approaches, the reputation may be adjusted in proportion to the magnitude of the historical proportion of transactions, or inversely proportional to the magnitude of the historical proportion of transactions.

Accordingly, if a particular pair of entities transact frequently with one another (N is large) but infrequently with other entities of the online marketplace ((N₁+N₂) is small)), it may be advantageous to reduce the impact of transactions between the entities since the entities may have motivation to improperly influence one another's reputations, either positively or negatively. Thus, it may be appropriate in such circumstances to decrease the impact of the reputation adjustment for such a transaction by an amount proportionate to the value of the historical proportion of transactions.

On the other hand, if parties do not transact frequently with one another, but transact frequently with other entities in the online marketplace, it may be appropriate to increase the impact of the reputation adjustment for such a transaction by an amount proportionate to the value of the historical proportion of transactions. Equivalently, it may be appropriate in such circumstances to decrease the impact of the reputation adjustment for such a transaction by an amount inversely proportionate to the value of the historical proportion of transactions.

Preferred embodiments of the present disclosures follow the latter approach, and all reputation factors result in a reduction of the impact suggested by the transacting party, but the degree of the reduction is a function of the entities' behavior within the online marketplace.

In more embodiments, and similarly in order to address problems arising from a particular transaction or set of transactions being associated with a disproportionate or improper reputation adjustment magnitude, the historical proportion of reputation currency transferred between the transacting entities relative to historical reputation currency transferred between the transacting entities and other entities of the online marketplace may be utilized.

Thus, with continuing reference to the exemplary scenario involving two entities, in one embodiment reputation tracking involves determining a historical proportion of reputation currency transferred between the entities participating in the transaction attempt. The historical proportion of transactions conducted between the at least two entities is preferably defined as:

$$\frac{M}{( {M}_{1} + {M}_{2} )}$$

where: M is a historical amount of reputation currency transferred between the at least two entities; M₁ is an amount of reputation currency transferred between a first of the at least two entities and other entities of the online marketplace not participating in the transaction attempt to which the rate reputation request relates; and M₂ is an amount of reputation currency transferred between a second of the at least two entities and other entities of the online marketplace not participating in the transaction attempt to which the rate reputation request relates.

With reference to the exemplary scenario involving more than two entities, in one embodiment reputation tracking involves determining a historical proportion of reputation currency transferred between the entities participating in the transaction attempt. The historical proportion of transactions conducted between the at least two entities is preferably defined as:

$$\frac{M}{( {M}_{1} + {M}_{2} + … + {M}_{n} )}$$

where: M; M₁ and M₂ are defined as above, and Mₙ is an amount of reputation currency transferred between an optional N^{th} of the at least two entities and other entities of the online marketplace not participating in the transaction attempt to which the rate reputation request relates.

In particularly preferred approaches, M is a historical amount of reputation currency transferred between the at least two entities; M₁ is an amount of reputation currency received by the seller entity from other entities of the online marketplace not participating in the transaction attempt to which the present rate reputation request relates; and M₂ is an amount of reputation transferred by a buyer entity to other entities of the online marketplace not participating in the transaction attempt to which the rate reputation request relates.

As noted above regarding historical proportion of transactions, the historical proportion of reputation currency transferred between the entities involved in the transaction may be used as a weight or multiplier to adjust a user-suggested reputation currency value. The adjustment may be in proportion, inverse proportion, etc. to the value of the historical proportion of reputation currency, in various embodiments. In preferred approaches, the higher the value of the historical proportion of reputation currency, the greater the reduction to the reputation currency adjustment for that transaction.

Further still, it is advantageous to provide some intelligence with regard to sample size during the reputation adjustment process, since each validator reviewing reputation adjustment information in connection with a particular transaction may have a limited view of the behavior of a particular entity 302 within the online marketplace. Accordingly, a fourth reputation factor contemplated in the course of preferred implementations of the presently disclosed inventive consensus-based reputation tracking techniques is a confidence score of the particular validator with respect to transactions between a particular set of entities.

In preferred approaches, the confidence score is a function of a number of transactions between the particular entities that the validator has previously reviewed, and an accuracy measure reflecting distance between the reputation adjustment computed for the validator and a final reputation adjustment determined based on the consensus of some or all validators in the online marketplace. The accuracy measure preferably is adjusted following each transaction in which the validator participates with respect to the entities. Preferably, the confidence score is calculated by taking into account the number of transactions for which the validator has evaluated the presently transacting entities, in relation to a total number of transactions in which the validator has participated.

In various approaches, the confidence score may therefore be the dividend of the number of transactions for which the validator has evaluated the presently transacting entities and the total number of transactions in which the validator has participated. As this number will always be a value between zero and one, the confidence measure may serve as a weight or multiplier by which the adjusted reputation currency is modified.

In more approaches, it is useful to employ linear regression, particularly with regard to the accuracy measure component of the confidence score, and/or to combine the accuracy measure and/or sample size components of the confidence score to achieve a final confidence score value. Those having ordinary skill in the art will appreciate equivalent techniques for combining the accuracy measure and sample size components to arrive at a suitable confidence score upon reading the present descriptions. For instance, training-based approaches such as machine learning techniques may be employed in various embodiments.

In particularly preferred approaches, the presently disclosed inventive techniques involve sequentially analyzing and/or adjusting reputation currency of a particular transaction. The sequence preferably includes first evaluating transaction validity, and setting the reputation currency for the transaction to null if the transaction is invalid, otherwise retaining the reputation currency amount suggested by the transacting entity. Subsequently, the historical proportion of transactions are evaluated, and the entity-suggested reputation currency amount adjusted based thereon. Third, the historical proportion of transaction currency is evaluated, and the reputation currency amount previously adjusted based on the historical proportion of transactions is further adjusted based on the historical proportion of transaction currency. Finally, the confidence score is determined and the reputation currency amount previously adjusted based on the historical proportion of transactions and the historical proportion of transaction currency is further adjusted based on the confidence score.

Regardless of the particular manner in which the reputation adjustment is calculated by the various nodes of the online marketplace, in preferred embodiments the presently disclosed inventive concepts leverage the calculations of the various nodes to generate a consensus reputation adjustment, which is ultimately applied to the particular entity or entities involved in the transaction. Preferably, the consensus is generated by computing a mean of the various individual reputation adjustments calculated by the individual nodes.

Similarly, in order to frustrate attempts to improperly influence reputation by modifying a single transaction history or reputation repository, the consensus reputation adjustment is preferably applied and distributed across the architecture to ensure robustness from tampering. For instance, in preferred approaches the reputation information is distributed across the architecture by modifying fields in an existing data structure storing reputation information regarding entities of the architecture, as described above with reference to the block chain data structure in one exemplary embodiment.

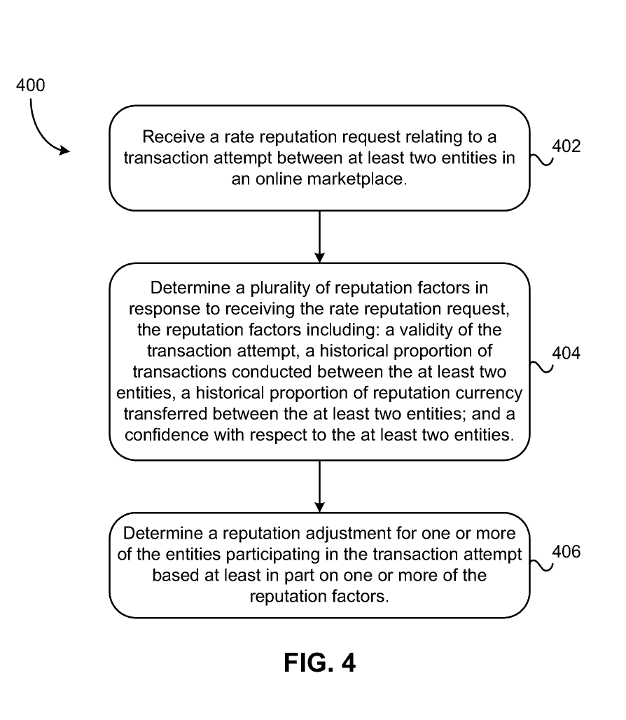

Now referring to FIG. 4, a flowchart of a method 400 is shown according to one embodiment. The method 400 may be performed in accordance with the present invention in any of the environments depicted in FIGS. 1-2 and 3B, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by one or more validator nodes of an online marketplace, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a rate reputation request is received at a validator node of an online marketplace. The rate reputation request relates to a transaction attempt between two (or more) entities of the online marketplace, e.g. a buyer and a seller. While transactions between any number of parties are fully within the scope of the present disclosures, for sake of simplicity and in the context of the most common transaction types, the present descriptions will be made primarily with respect to a transaction between two entities.

Preferably, and particularly in the context of distributed database embodiments such as a block chain implementation, the rate reputation request is generated and received following completion of an asset transfer request and a corresponding payment transfer request. In this manner, it is possible to constrict rate reputation requests to appropriate circumstances, e.g. where a transaction attempt has been completed (i.e. each “side” of the transaction has submitted the requisite information, corresponding to the goods/services and payment therefor as contemplated in the transaction attempt).

Method 400 also includes operation 404, in which a plurality of reputation factors are determined in response to receiving the rate reputation request in operation 402. The reputation factors include one or more of: a validity of the transaction attempt to which the rate reputation request relates; a historical proportion of transactions conducted between the at least two entities participating in the transaction attempt; a historical proportion of reputation currency transferred between the at least two entities participating in the transaction attempt; and a confidence of the validator node with respect to the at least two entities.

In various embodiments, and as discussed above, each reputation factor plays a unique role in the overall reputation adjustment for the transaction, and thus contributes to robustness of reputation tracking within the online marketplace. As a whole, the combination of reputation factors provide the greatest robustness to address the problems uniquely associated with untrustworthiness of conventional online marketplaces, transactions and the reputation tracking systems implemented thereby.

Method 400 further includes determining a reputation adjustment for one or more entities participating in the transaction attempt in operation 406. The reputation adjustment is determined based in whole or in part on one or more of the reputation factors determined in operation 404, and preferably based on all of the reputation factors.

In line with the consensus-based implementation of the presently disclosed inventive concepts, within an online marketplace such as architecture 310 as shown in FIG. 3B, the method 400 may be performed by a plurality of entities 302 of the architecture, e.g. a plurality of data stores, validation nodes, etc. as would be understood by a person having ordinary skill in the art upon reading the present descriptions.

Preferably, the method 400 is performed by substantially all entities 302 of the architecture 310, or all entities 302 tasked with validation functions. Regardless of the number of entities 302 configured to perform the method 400, in particularly preferred approaches upon each entity 302 determining a reputation adjustment for the one or more entities participating in the transaction attempt, the various reputation adjustments are compiled and/or compared to determine a final reputation adjustment amount. For instance, in one approach the final reputation adjustment amount is an average of the various individual reputation adjustments determined by the individual entities 302. The final reputation adjustment may be determined by any of the entities 302 of the architecture 310, or another component (not shown) of the architecture 310, in various embodiments.

Upon determining the final reputation adjustment, the presently disclosed inventive techniques also preferably include distributing the final reputation adjustment across a plurality of entities 302 storing reputation information for the online marketplace. For instance, in preferred embodiments each entity 302 maintaining an instance of the public ledger by which transaction validity is maintained may have distributed thereto the final reputation adjustment. In this manner, the presently disclosed inventive techniques frustrate attempts to improperly influence a reputation adjustment (e.g. a negative review) by a single entity, as is a common problem with conventional, trusted-party based reputation tracking systems. Accordingly, this distribution of the reputation adjustment information facilitates consumer confidence and reliability of the online marketplace reputation tracking system.

In particularly preferred embodiments where the presently disclosed inventive concepts are implemented in the context of a block chain validation process, the reputation adjustment functionality disclosed herein is also tracked and maintained utilizing block chain principles known in the art, such that the reputation adjustment may be appended to existing transaction validation techniques as a means for providing reputation tracking within the general framework of the existing block chain architecture.

The presently disclosed inventive concepts have wide applicability across nearly any type of online marketplace, and particularly online marketplaces in which reputation information is an important component of consumer decision making. Exemplary use-cases include online consumer exchanges such as EBAY®, AMAZON®, TAOBAO®, TMALL®, etc. online gaming applications, online forums (e.g. for product/service review), etc. as would be understood by a person having ordinary skill in the art upon reading the present descriptions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method for blockchain-based reputation tracking in an online marketplace, the method comprising:
receiving, at a validator node of the online marketplace, a rate reputation request, the rate reputation request relating to a transaction attempt between at least two entities in the online marketplace;
in response to receiving the rate reputation request, determining by the validator node a plurality of reputation factors comprising:
a validity of the transaction attempt to which the rate reputation request relates;
a historical proportion of transactions conducted between the at least two entities participating in the transaction attempt;
a historical proportion of reputation currency transferred between the at least two entities participating in the transaction attempt; and
a confidence of the validator node with respect to the at least two entities; and
determining, by the validator node, a reputation adjustment for one or more of the at least two entities participating in the transaction attempt, the reputation adjustment being based at least in part on one or more of the plurality of reputation factors.

2. The computer-implemented method of claim 1, comprising updating a public ledger of the online marketplace with the reputation adjustment for one or more of the at least two entities participating in the transaction attempt; and
creating a new block in the public ledger.

3. The computer-implemented method of claim 1, comprising receiving a plurality of reputation adjustments from a plurality of validator nodes of the online marketplace; and
generating a consensus reputation adjustment based on the plurality of reputation adjustments.

4. The computer-implemented method of claim 3, comprising applying the consensus reputation adjustment to a reputation of one or more of the at least two entities participating in the transaction attempt.

5. The computer-implemented method of claim 1, wherein the rate reputation request comprises a user-defined sign of the reputation adjustment and a user-suggested magnitude of the reputation adjustment; and
wherein determining the reputation adjustment for one or more of the at least two entities participating in the transaction attempt consists of adjusting the user-suggested magnitude of the reputation adjustment based on:
the validity of the transaction attempt to which the rate reputation request relates;
the historical proportion of transactions conducted between the at least two entities;
the historical proportion of reputation currency transferred between the at least two entities; and
the confidence of the validator node with respect to the at least two entities.

6. The computer-implemented method of claim 1, comprising setting the reputation adjustment to zero in response to determining the transaction attempt to which the rate reputation request relates is invalid.

7. The computer-implemented method of claim 1, wherein determining the historical proportion of transactions conducted between the at least two entities comprises comparing a historical number of transactions between the at least two entities to a number of transactions conducted between each of the at least two entities and other entities of the online marketplace not participating in the transaction attempt to which the rate reputation request relates.

8. The computer-implemented method of claim 7, wherein the historical proportion of transactions conducted between the at least two entities is defined by:
$$\frac{N}{( {N}_{1} + {N}_{2} + … + {N}_{n} )}$$
wherein:
N is a historical number of transactions between the at least two entities;
N₁ is a number of transactions conducted between a first of the at least two entities and other entities of the online marketplace not participating in the transaction attempt to which the rate reputation request relates;
N₂ is a number of transactions conducted between a second of the at least two entities and other entities of the online marketplace not participating in the transaction attempt to which the rate reputation request relates; and
Nₙ is a number of transactions conducted between an optional N^{th} of the at least two entities and other entities of the online marketplace not participating in the transaction attempt to which the rate reputation request relates.

9. The computer-implemented method of claim 1, comprising reducing a magnitude of the reputation adjustment by an amount proportional to a magnitude of the historical proportion of transactions conducted between the at least two entities.

10. The computer-implemented method of claim 1, wherein determining the historical proportion of reputation currency transferred between the at least two entities comprises comparing a historical amount of reputation currency transferred between the at least two entities to a historical amount of reputation currency transferred between each of the at least two entities and other entities of the online marketplace not participating in the transaction attempt to which the rate reputation request relates.

11. The computer-implemented method of claim 10, wherein the historical proportion of reputation currency transferred between the at least two entities is defined by:
$$\frac{M}{( {M}_{1} + {M}_{2} + … + {M}_{n} )}$$
wherein:
M is a historical amount of reputation currency transferred between the at least two entities;
M₁ is an amount of reputation currency transferred between a first of the at least two entities and other entities of the online marketplace not participating in the transaction attempt to which the rate reputation request relates;
M₂ is an amount of reputation currency transferred between a second of the at least two entities and other entities of the online marketplace not participating in the transaction attempt to which the rate reputation request relates; and
Mₙ is an amount of reputation currency transferred between an optional N^{th} of the at least two entities and other entities of the online marketplace not participating in the transaction attempt to which the rate reputation request relates.

12. The computer-implemented method of claim 1, comprising reducing a magnitude of the reputation adjustment by an amount proportional to a magnitude of the historical proportion of reputation currency transferred between the at least two entities.

13. The computer-implemented method of claim 1, wherein the confidence of the validator node with respect to the at least two entities is based at least in part on:
a historical proportion of transactions between the validator node and the at least two entities relative to a total number of transactions in which the validator node has participated in the online marketplace; and
a difference between a magnitude of the reputation adjustment for the one or more of the at least two entities participating in the transaction attempt and a magnitude of a reputation adjustment for at least one prior transaction attempt between the at least two entities.

14. A computer program product for consensus-based reputation tracking in an online marketplace, the computer program product comprising a computer readable storage medium having stored thereon:
first program instructions executable by a validator node of the online marketplace to cause the validator node to receive a rate reputation request, the rate reputation request relating to a transaction attempt between at least two entities in the online marketplace;
second program instructions executable by the validator node of the online marketplace to cause the validator node to determine a plurality of reputation factors comprising:
a validity of the transaction attempt to which the rate reputation request relates;
a historical proportion of transactions conducted between the at least two entities participating in the transaction attempt;
a historical proportion of reputation currency transferred between the at least two entities participating in the transaction attempt; and
a confidence of the validator node with respect to the at least two entities;
third program instructions executable by the validator node of the online marketplace to cause the validator node to determine a reputation adjustment for one or more of the at least two entities participating in the transaction attempt, the reputation adjustment being based at least in part on one or more of the plurality of reputation factors; and
wherein the computer readable storage medium is not a transitory signal per se.

15. The computer program product of claim 14, comprising receiving a plurality of reputation adjustments from a plurality of validator nodes of the online marketplace; and
generating a consensus reputation adjustment based on the plurality of reputation adjustments.

16. The computer program product of claim 15, comprising applying the consensus reputation adjustment to a reputation of one or more of the at least two entities participating in the transaction attempt.

17. The computer program product of claim 14, wherein the rate reputation request comprises a user-defined sign of the reputation adjustment and a user-suggested magnitude of the reputation adjustment; and
wherein determining the reputation adjustment for one or more of the at least two entities participating in the transaction attempt consists of adjusting the user-suggested magnitude of the reputation adjustment based on:
the validity of the transaction attempt to which the rate reputation request relates;
the historical proportion of transactions conducted between the at least two entities;
the historical proportion of reputation currency transferred between the at least two entities; and
the confidence of the validator node with respect to the at least two entities.

18. A system for consensus-based reputation tracking in an online marketplace, the system comprising:
a processor and logic integrated with and/or executable by the processor, the logic being configured to cause the system to perform a method comprising:
receiving, at a validator node of the online marketplace, a rate reputation request, the rate reputation request relating to a transaction attempt between at least two entities in the online marketplace;
in response to receiving the rate reputation request, determining by the validator node a plurality of reputation factors comprising:
a validity of the transaction attempt to which the rate reputation request relates;
a historical proportion of transactions conducted between the at least two entities participating in the transaction attempt;
a historical proportion of reputation currency transferred between the at least two entities participating in the transaction attempt; and
a confidence of the validator node with respect to the at least two entities; and
determining, by the validator node, a reputation adjustment for one or more of the at least two entities participating in the transaction attempt, the reputation adjustment being based at least in part on one or more of the plurality of reputation factors.

19. The system of claim 18, comprising receiving a plurality of reputation adjustments from a plurality of validator nodes of the online marketplace; and generating a consensus reputation adjustment based on the plurality of reputation adjustments.

20. The system of claim 19, comprising applying the consensus reputation adjustment to a reputation of one or more of the at least two entities participating in the transaction attempt.
